(19) United States
(12) Patent Application Publication
(10) Pub. No.: US 2017/0019845 A1
(43) Pub. Date: Jan. 19, 2017

(54) COMMUNICATION TERMINAL, COMMUNICATION METHOD, AND PROGRAM-CONTAINING STORAGE MEDIUM

(71) Applicant: NEC Corporation, Tokyo (JP)

(72) Inventor: Fumitaka NAKAHARA, Tokyo (JP)

(73) Assignee: NEC Corporation, Tokyo (JP)

(21) Appl. No.: 15/124,941

(22) PCT Filed: Feb. 18, 2015
(86) PCT No.: PCT/JP2015/000739

§ 371 Date: Sep. 9, 2016

(30) Foreign Application Priority Data
Mar. 28, 2014 (JP) 2014-068372

(51) Int. Cl. H04W 48/18; H04L 12/46; H04L 12/813

(52) U.S. Cl. CPC H04W 48/18; H04L 47/20; H04L 12/4641; H04W 88/06

(57) ABSTRACT

In order to make it possible to select communication interface in accordance with features of access networks, the terminal includes a plurality of communication interfaces each of which corresponds to at least one of the plurality of networks. The terminal includes a communication means capable of selecting the communication interface through which communication with the connection destination is performed based on whether a network corresponding to each of the plurality of communication interfaces is communicable with the connection destination.

### TECHNICAL FIELD

The present invention relates to a communication terminal, a communication method, and a program-containing storage medium.

### BACKGROUND ART

A communication terminal, such as a mobile phone, is provided with a plurality of communication interfaces and is capable of connecting to a plurality of types of RATs (Radio Access Technology).

In PTL 1, a technology in which, in selecting a communication interface based on a connection destination host name and a domain name, a mobile communication terminal refers to predefined association relationships between host names and communication interfaces to make the selection is disclosed. A mobile communication terminal described in PTL 1, referring to a host name to communication interface conversion table with which the mobile communication terminal is provided, specifies a communication interface serving as a communication path to be used from a host name input from an application program. The mobile communication terminal communicates with the connection destination host by way of an access network corresponding to the specified communication interface.

### CITATION LIST

### Patent Literature

[PTL 1] JP 2006-333080 A

[PTL 2] JP 2013-201685 A

### SUMMARY OF INVENTION

### Technical Problem

There may be a case in which a mobile communication terminal cannot communicate with a desired connection destination host, depending on, for example, access restrictions and the like in an access network.

However, the technology described in PTL 1 selects a communication interface without taking into consideration features of an access network as described above. Thus, there is a possibility that a mobile communication terminal using the technology in PTL 1 cannot communicate with a connection destination host depending on features of an access network.

An object of the present invention is to provide a communication terminal, a communication method, and a program-containing storage medium that solve the above-described problem and are capable of selecting a communication interface in accordance with features of access networks.

### Solution to Problem

A communication terminal of the present invention, in a communication terminal that communicates with a connection destination by way of at least one of a plurality of networks, includes a plurality of communication interfaces each of which corresponds to at least one of the plurality of networks and a communication means capable of selecting the communication interface through which communication with the connection destination is performed based on whether or not a network corresponding to each of the plurality of communication interfaces is communicable with the connection destination.

A communication method of the present invention includes communicating with a connection destination by way of at least one of a plurality of networks, wherein, based on whether or not a network corresponding to each of a plurality of communication interfaces each of which corresponds to at least one of the plurality of networks is communicable with the connection destination, the communication interface through which communication with the connection destination is performed is selectable.

A storage medium storing a program of the present invention stores a program that makes a computer execute a process of communicating with a connection destination by way of at least one of a plurality of networks and a process in which, based on whether or not a network corresponding to each of a plurality of communication interfaces each of which corresponds to at least one of the plurality of networks is communicable with the connection destination, the communication interface through which communication with the connection destination is performed is selectable.

### Advantageous Effects of Invention

The present invention enables a communication terminal, a communication method, and a program-containing storage medium that are capable of selecting a communication interface in accordance with features of access networks to be provided.

### BRIEF DESCRIPTION OF DRAWINGS

FIG. 1 is a diagram illustrating a configuration example of a communication system in a first exemplary embodiment of the present invention;

FIG. 2 is a diagram illustrating a configuration example of a communication terminal 1 in the first exemplary embodiment of the present invention;

FIG. 3 is a flowchart illustrating an operation example of the communication terminal 1 in the first exemplary embodiment of the present invention;

FIG. 4 is a diagram illustrating a configuration example of a communication system in a second exemplary embodiment of the present invention;

FIG. 5 is a diagram illustrating a configuration example of a communication terminal 1 in the second exemplary embodiment of the present invention;

FIG. 6 is an example of information stored in a policy storage unit 14 in the second exemplary embodiment of the present invention;

FIG. 7 is another example of the information stored in the policy storage unit 14 in the second exemplary embodiment of the present invention;

FIG. 8 is still another example of the information stored in the policy storage unit 14 in the second exemplary embodiment of the present invention;

FIG. 9 is still another example of the information stored in the policy storage unit 14 in the second exemplary embodiment of the present invention;

FIG. 10 is a flowchart illustrating an operation example of the communication terminal 1 in the second exemplary embodiment of the present invention;

FIG. 11 is a diagram illustrating a configuration example of a communication system in a third exemplary embodiment of the present invention;

FIG. 12 is a diagram illustrating a configuration example of a management device 6 in the third exemplary embodiment of the present invention;

FIG. 13 is an example of operation policies stored in an operation policy storage unit 62 in the third exemplary embodiment of the present invention;

FIG. 14 is a diagram illustrating a configuration example of a communication terminal 1 in the third exemplary embodiment of the present invention;

FIG. 15 is a flowchart illustrating an operation example of the communication terminal 1 in the third exemplary embodiment of the present invention;

FIG. 16 is a diagram illustrating an outline of a communication system configured using an OpenFlow technology;

FIG. 17 is a diagram illustrating a configuration example of each entry (flow entry) in a flow table 103;

FIG. 18 is a diagram illustrating a configuration example of a communication system in a fourth exemplary embodiment of the present invention;

FIG. 19 is a diagram illustrating a configuration example of a control device 10 in the fourth exemplary embodiment of the present invention;

FIG. 20 is a diagram illustrating an example of processing rules generated by a processing rule determination unit 721 in the fourth exemplary embodiment of the present invention;

FIG. 21 is a diagram illustrating an example of a configuration of a communication terminal 1 in the fourth exemplary embodiment of the present invention; and

FIG. 22 is a sequence diagram illustrating an operation example in the fourth exemplary embodiment of the present invention.

### DESCRIPTION OF EMBODIMENTS

### First Exemplary Embodiment

A first exemplary embodiment of the present invention will be described below with reference to the drawings.

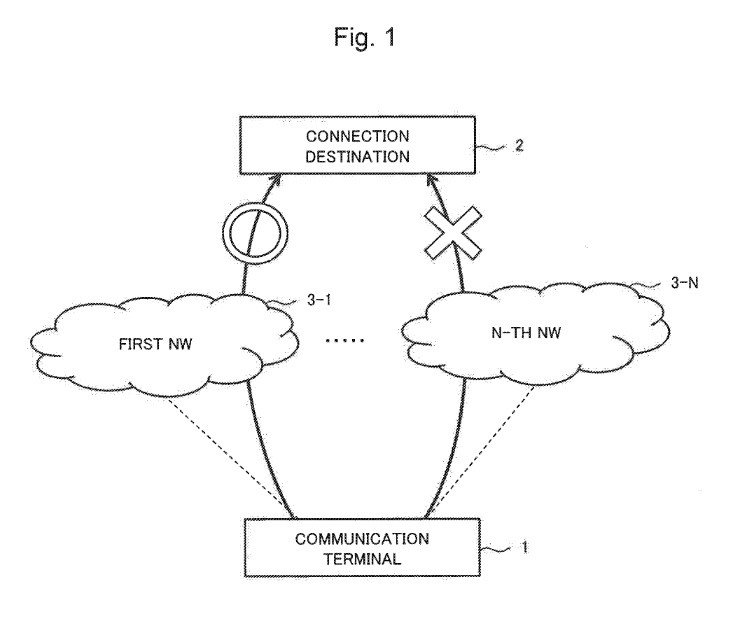

FIG. 1 is a diagram illustrating a configuration example of a communication system in the first exemplary embodiment of the present invention. As illustrated in FIG. 1, the communication system includes a communication terminal 1, a connection destination 2, and a plurality of NWs (Networks) 3-1 to 3-N (when discrimination is not particularly required, referred to as “NWs 3”).

The communication terminal 1 is, for example, a device having a communication function, such as a mobile phone, a personal computer, and a mobile router. A mobile router is, for example, a terminal that relays communication between a mobile phone 3G network and a wireless LAN network. The communication terminal 1 communicates with the connection destination 2 by way of at least one of the plurality of NWs 3.

The connection destination 2 is a device with which the communication terminal 1 communicates and is, for example, a Web server, a mail server, a video server, a mobile phone, a personal computer, or a home appliance. Without limited to the examples, the connection destination 2 may be any type of device as long as being a device that communicates with the communication terminal 1.

Each of the NWs 3 is a wireless network to which the communication terminal 1 can be connected using a communication method, such as 3G (3rd. Generation), LTE (Long Term Evolution), and wireless LAN (Local Area Network). The wireless network may also be a network to which the communication terminal 1 can be connected using a communication method, such as Wi-MAX (Worldwide Interoperability for Microwave Access) and PHS (Personal Handy-phone System). Each of the NWs 3 may also be a wired NW, such as an Ethernet (registered trademark) and a dedicated line.

To each of the NWs 3, an operation policy(ies) is/are set. Operation policies include, for example, a policy of restricting access to a predetermined connection destination 2 and a policy of restricting access to a global network, such as the Internet.

When a NW 3 is a corporate intranet, a policy of shutting off a connection to a predetermined connection destination 2 (access restriction) is set to the NW 3 in some cases. In such a case, the communication terminal 1 is unable to communicate with the predetermined connection destination 2 by way of the corporate intranet. The predetermined connection destination 2 is, for example, a server providing a specific service, exemplified by a server providing video contents, a server providing a bulletin board system (BBS) into which information can be written, and the like. The NW 3 is not limited to the examples, and, when the NW 3 is, for example, a corporate intranet, a policy(ies) can be set freely by an administrator of the corporate intranet.

When a NW 3 is a local network or a private network provided for use by customers at a shop and the like, the NW 3 imposes restriction on connection to a global network, such as the Internet, in some cases. There is also a case in which the NW 3, in the first place, is not connected to the global network. In such cases, the communication terminal 1 is unable to access the global network by way of the local network or private network and thus unable to connect to various connection destinations 2 that are accessible by way of the global network.

The plurality of NWs 3 included in the communication system do not have to be of types different from one another and may include NWs 3 of the same type. For example, in FIG. 1, when the NW 3-1 is a wireless LAN, the NW 3-N may be another wireless LAN.

In the example in FIG. 1, as a feature of the N-th NW 3-N, access to the connection destination 2 is, for example, restricted. In this case, the communication terminal 1 is able to connect to the connection destination 2 by way of the first NW 3-1 but unable to connect to the connection destination 2 by way of the N-th NW 3-N.

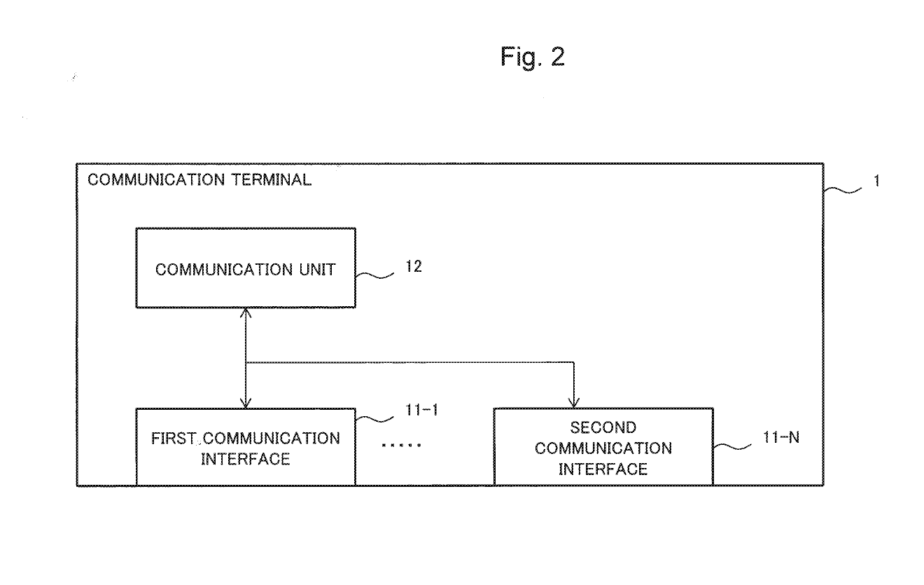

FIG. 2 is a diagram illustrating a configuration example of the communication terminal 1 in the first exemplary embodiment of the present invention. As illustrated in FIG. 2, the communication terminal 1 includes a plurality of communication interfaces 11-1 to 11-N (when discrimination is not particularly required, referred to as “communication interfaces 11”) and a communication unit 12. The configuration illustrated in FIG. 2 is, however, only an illustration, and the configuration of the communication terminal 1 is not limited to the configuration in FIG. 2.

Each of the plurality of communication interfaces 11 is, for example, an antenna. Each communication interface 11 corresponds to at least one of the plurality of NWs 3 illustrated in FIG. 1. For example, by way of a communication interface 11 that corresponds to an LTE network, which is one of the NWs 3, the communication terminal 1 connects to the LTE network.

The communication unit 12 connects to a NW 3 by way of at least one of the plurality of communication interfaces 11. The communication unit 12 is capable of selecting a communication interface 11 through which communication with the connection destination 2 is performed based on whether or not a NW 3 corresponding to each of the plurality of communication interfaces 11 is communicable with the connection destination 2. The communication unit 12, for example, selects a communication interface 11 through which communication with the connection destination 2 is performed out of communication interfaces 11 corresponding to NWs 3 that are communicable with the connection destination 2.

The communication unit 12 is capable of selecting a communication interface 11 through which communication with the connection destination 2 is performed in accordance with, for example, an operation policy(ies) of each of the plurality of NWs 3. In this case, the communication unit 12 is notified of operation policies by the NWs 3 in connecting to the connection destination 2. The operation policies include, as described above, a policy of restricting access to a predetermined connection destination(s) 2 and a policy of restricting access to a global network(s), such as the Internet. An operation policy notified by a NW 3 is, for example, a policy on access restriction of the NW 3. An operation policy notified by a NW 3 may be, for example, a policy indicating that the NW 3 and a predetermined connection destination 2 are, in the first place, not connected to each other, and it is thus impossible to connect the NW 3 to the predetermined connection destination 2.

In the example in FIG. 1, the communication unit 12 is notified of a policy of restricting access to the connection destination 2 by the N-th NW 3-N. Specifically, the communication unit 12 is notified, by the N-th NW 3-N, of information on the connection destination 2 the access to which is restricted. The information on the connection destination 2 includes, for example, an “address” and a “waiting port number” of the connection destination 2 and a “protocol” to be used.

In this case, when communicating with the connection destination 2, the communication unit 12 communicates with the connection destination 2 by way of a communication interface 11 other than the communication interface 11-N corresponding to the N-th NW 3-N (for example, the communication interface 11-1).

An operation policy may be, for example, information on a connection destination(s) 2 the connection to which by way of a NW 3 is allowed. In such a case, the communication unit 12 is able to select a communication interface 11 through which communication with the connection destination 2 is performed out of communication interfaces 11 corresponding to NWs 3 that have notified information including the connection destination 2.

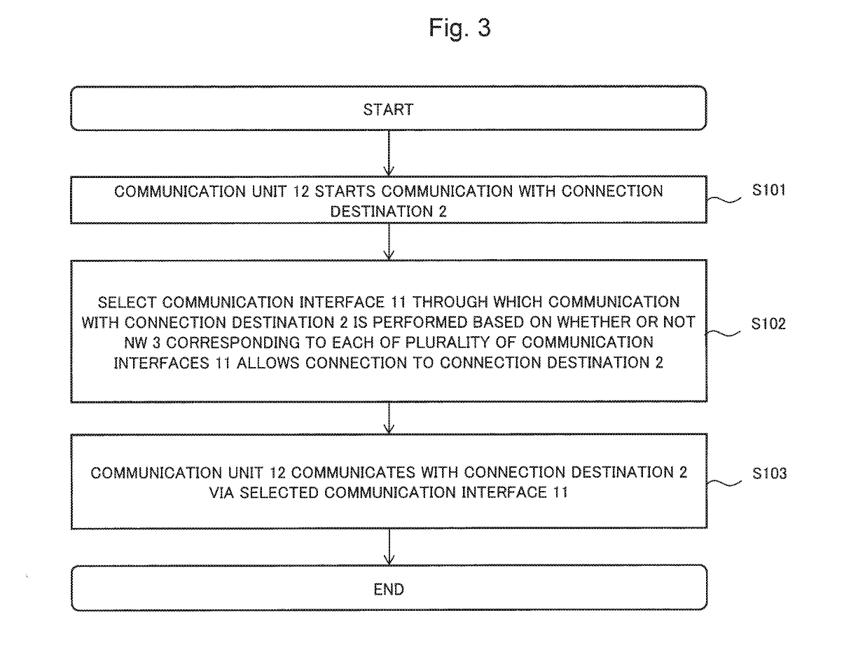

FIG. 3 is a flowchart illustrating an operation example of the communication terminal 1 in the first exemplary embodiment of the present invention.

When the communication unit 12 starts communication with the connection destination 2 (S101), the communication unit 12 selects a communication interface 11 through which communication with the connection destination 2 is performed based on whether or not a NW 3 corresponding to each of the plurality of communication interfaces 11 allows connection to the connection destination 2 (S102).

The communication unit 12 communicates with the connection destination 2 by way of the selected communication interface 11 (S103).

As described above, when communicating with a connection destination 2, the communication terminal 1 of the first exemplary embodiment of the present invention is capable of selecting a communication interface 11 through which communication with the connection destination 2 is performed based on whether or not a NW 3 corresponding to each of the plurality of communication interfaces 11 allows connection to the connection destination 2. The capability enables the communication terminal 1 to select a communication interface in accordance with features of access networks.

### Second Exemplary Embodiment

A second exemplary embodiment of the present invention will be described below with reference to the drawings. In the second exemplary embodiment of the present invention, a description of the same configurations as those of the first exemplary embodiment of the present invention will be omitted.

In the second exemplary embodiment of the present invention, a DHCP server incorporates an operation policy(ies) of a NW 3 into a response to a request for an address that a communication terminal 1 uses.

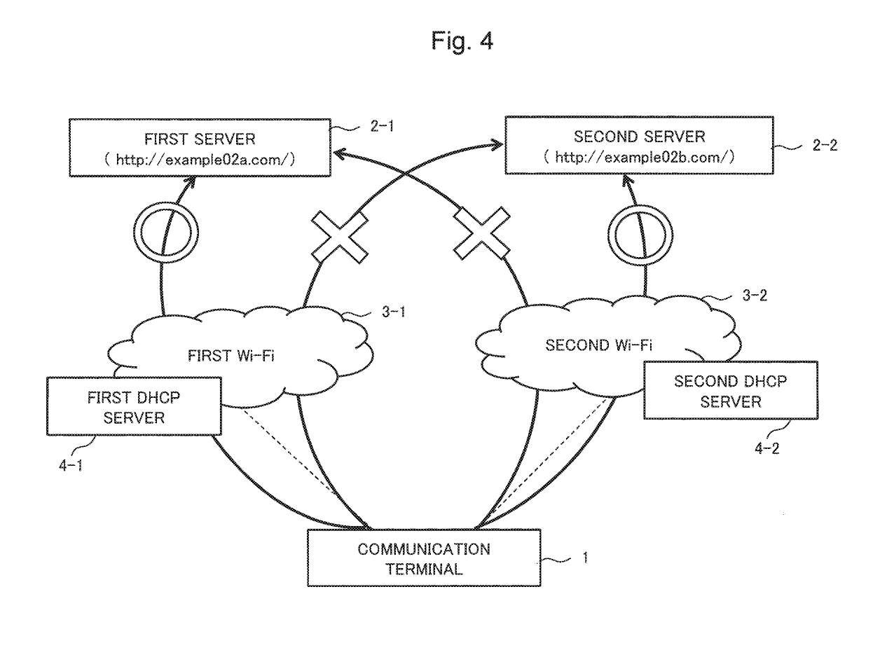

FIG. 4 is a diagram illustrating a configuration example of a communication system in the second exemplary embodiment of the present invention. The communication system includes a communication terminal 1, a plurality of connection destinations 2 (in the example in FIG. 4, a first server 2-1 and a second server 2-2), and a plurality of NWs 3 (in the example in FIG. 4, a first Wi-Fi 3-1 and a second Wi-Fi 3-2). The communication system also includes a DHCP server 4 for each of the plurality of NWs 3 (a first DHCP server 4-1 and a second DHCP server 4-2 in FIG. 4).

In the example in FIG. 4, as a feature of the first Wi-Fi 3-1, access to the second server 2-2 is restricted. On the other hand, as a feature of the second Wi-Fi 3-2, access to the first server 2-1 is restricted.

There is also a case in which, as a feature of the first Wi-Fi 3-1, the first Wi-Fi 3-1 and the second server 2-2 are, in the first place, not connected to each other. Similarly, there is also a case in which, as a feature of the second Wi-Fi 3-2, the second Wi-Fi 3-2 and the first server 2-1 are, in the first place, not connected to each other. It is conceivable that such a situation is exemplified by a case in which a server on which predetermined contents are available for customers visiting a station or a shop is installed in a local network that is not connected to a global network (the Internet and the like). In such a case, the communication terminal 1 is unable to access, by way of the local network, various connection destinations 2 that are connected to the global network. The communication terminal 1 is also unable to connect, by way of the global network, to the server on which predetermined contents are available.

When no address has been assigned to the communication terminal 1, each DHCP server 4, in response to a request from the communication terminal 1, notifies the communication terminal 1 of an address that the communication terminal 1 is able to use.

In the second exemplary embodiment of the present invention, the communication terminal 1 requests an IP address that the own device (communication terminal 1) uses to a DHCP server 4, using the DHCP protocol.

The communication terminal 1 transmits a DISCOVERY command requesting an IP address of the own device (communication terminal 1) to a DHCP server 4 installed to each NW 3 by way of each of a plurality of communication interfaces 11.

A DHCP server 4 that has received a DISCOVERY command transmits an OFFER command, which is a response to the DISCOVERY command and includes an IP address to be assigned to the communication terminal 1.

The DHCP protocol allows various information (option information) to be embedded in a predetermined area in a command. To each piece of option information, a tag number is assigned. Pieces of option information with tag numbers of 128 to 254 are provided to be used as extensions, and information to be embedded therein can be set freely.

Thus, in the second exemplary embodiment of the present invention, information to be embedded into, for example, a piece of option information with a tag number of 200 by each DHCP server 4 is defined to be an operation policy of the corresponding NW 3. Each DHCP server 4 embeds an operation policy of the corresponding NW 3 in an OFFER command, which includes an IP address that is to be assigned to the communication terminal 1.

Each DHCP server 4 may embed an operation policy of the corresponding NW 3 into a PACK command, an INFORM command, or the like in the DHCP protocol instead of an OFFER command.

As described above, the communication terminal 1 is able to acquire an operation policy in performing connection processing to a network (for example, processing of acquiring an address of the own device).

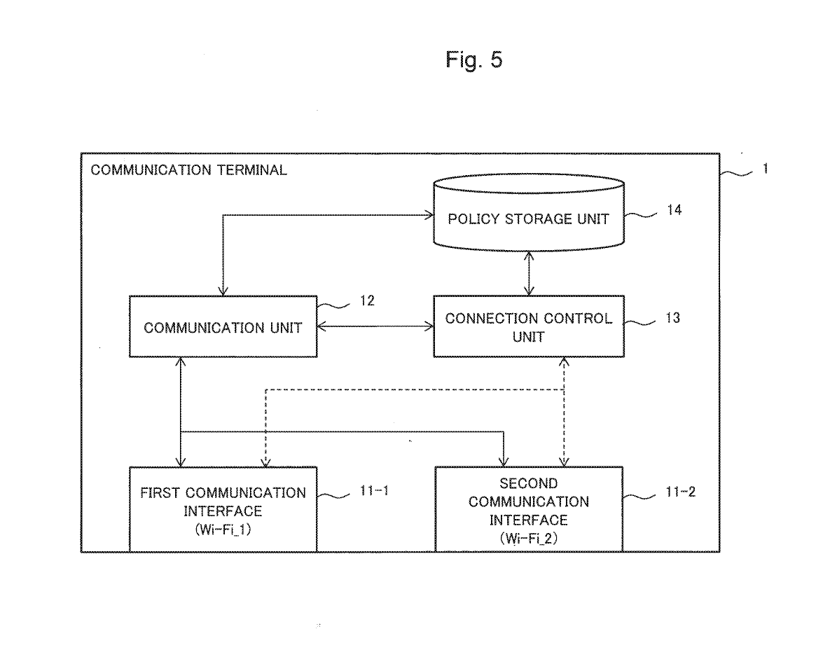

FIG. 5 is a diagram illustrating a configuration example of the communication terminal 1 in the second exemplary embodiment of the present invention. The communication terminal 1 includes a plurality of communication interfaces 11 (in the example in FIG. 5, a first communication interface 11-1 and a second communication interface 11-2), a communication unit 12, a connection control unit 13, and a policy storage unit 14.

The connection control unit 13 requests an IP address that the own device (communication terminal 1) uses by way of each of the plurality of communication interfaces 11. The connection control unit 13, for example, requests IP addresses to the first DHCP server 4-1 in the first Wi-Fi 3-1 and the second DHCP server 4-2 in the second Wi-Fi 3-2 illustrated in FIG. 4 by way of the communication interfaces 11-1 and 11-2.

When an operation policy of a NW 3 is included in an OFFER command, the connection control unit 13 makes the policy storage unit 14 store the operation policy and the identifier of the communication interface 11 that has received the information in association with each other.

As described in the first exemplary embodiment, operation policies include a policy of restricting access to a predetermined connection destination 2 and a policy of restricting access to a global network, such as the Internet.

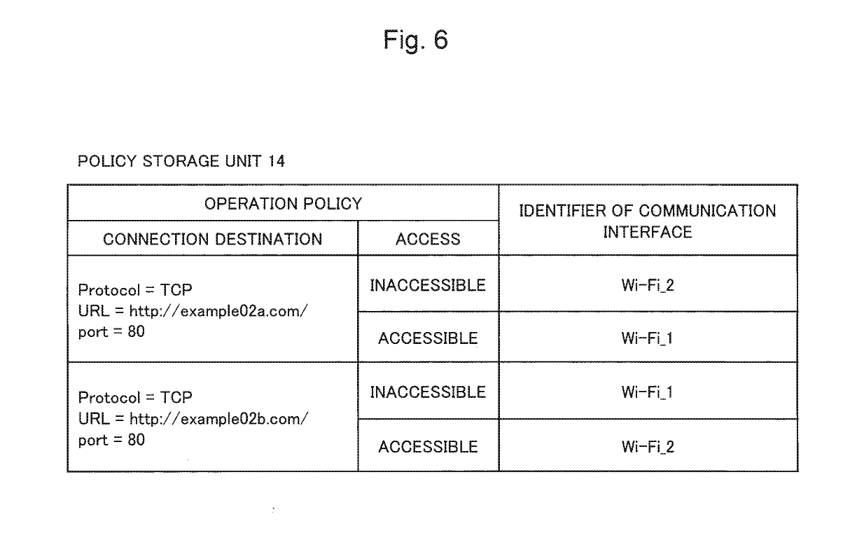

FIG. 6 illustrates an example of information that is stored in the policy storage unit 14 in the second exemplary embodiment of the present invention. As illustrated in FIG. 6, the policy storage unit 14 stores operation policies and the identifiers of communication interfaces 11 corresponding to NWs 3 that have notified the operation policies in association with each other.

The policy storage unit 14 stores, for example, an operation policy (information on the first server 2-1 and information on accessibility) and the identifier of the communication interface 11-1 corresponding to the Wi-Fi 2-2 that has notified the operation policy in association with each other.

Specifically, the policy storage unit 14 stores information on the first server 2-1, “inaccessible”, and the identifier “Wi-Fi_2” of a communication interface in association with one another. In a similar manner, the policy storage unit 14 stores information on the first server 2-1, “accessible”, and the identifier “Wi-Fi_1” of a communication interface in association with one another. The information of the first server 2-1 is, for example, “Protocol=TCP”, “URL=http://example02a.com/”, and a waiting port number “port=80”.

An operation policy may also be information on a connection destination 2 the connection to which by way of a NW 3 is allowed. That is, a DHCP server 4 included in each NW 3 may notify the communication terminal 1 of, as an operation policy, information on a connection destination 2 the connection to which is allowed. In this case, the policy storage unit 14 may store only accessible connection destinations 2 and does not have to store whether “accessible” or “inaccessible”.

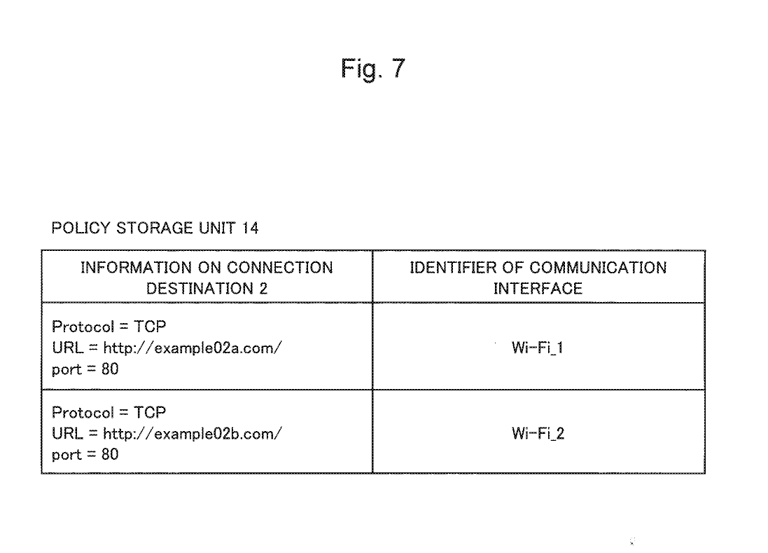

FIG. 7 illustrates another example of information stored in the policy storage unit 14 in the second exemplary embodiment of the present invention. As illustrated in FIG. 7, the policy storage unit 14 stores information on connection destinations 2 the connection to which by way of NWs 3 is allowed and the identifiers of communication interfaces 11 that have received the information in association with each other. Specifically, the policy storage unit 14 stores information on the first server 2-1 and the identifier “Wi-Fi_2” of a communication interface 11 that has received the information in association with each other.

An operation policy does not have to include information representing a connection destination (for example, URL) as in the examples in FIGS. 6 and 7. An operation policy may be, for example, a condition by which connection is restricted. For example, an operation policy may be a condition that is set based on a network domain to which a connection destination belongs and a domain of a NW 3. For example, an operation policy may be a condition prescribing that, when a network domain to which a connection destination belongs differs from a domain of a NW 3, the connection destination is inaccessible.

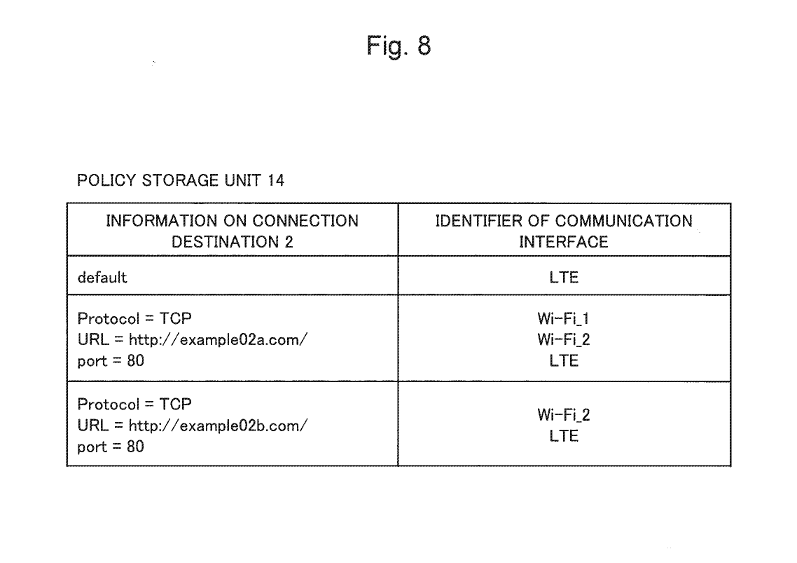

FIG. 8 illustrates still another example of information stored in the policy storage unit 14 in the second exemplary embodiment of the present invention. As illustrated in FIG. 8, in the policy storage unit 14, information on a connection destination 2 (for example, the first server 2-1) and a plurality of communication interfaces 11 are stored in association with each other. That is, the example in FIG. 8 is an example of a case in which there exist a plurality of NWs 3 that allow connection to a connection destination 2 (the first server 2-1). In such a case, the communication unit 12 selects a communication interface 11 that is used in communication with a connection destination 2 (the first server 2-1) based on degrees of priority each of which is set for one of the plurality of interfaces 11.

When degrees of priority are, for example, set in the descending order of (1) Wi-Fi_1, (2) Wi-Fi_2, and (3) LTE, the communication unit 12 selects a communication interface 11 that is used in communication with a connection destination 2 (the first server 2-1) so as to use the Wi-Fi_1, which has the highest degree of priority. The communication unit 12 may also select a communication interface 11 that is used in communication with a connection destination 2 (the first server 2-1), for example, at random out of the plurality of communication interfaces 11.

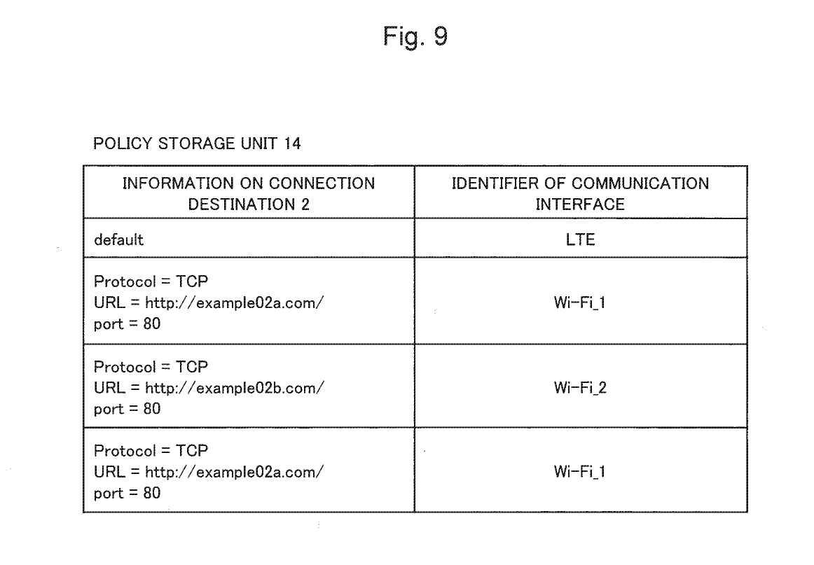

FIG. 9 illustrates a still another example of information stored in the policy storage unit 14 in the second exemplary embodiment of the present invention. As illustrated in FIG. 9, in the policy storage unit 14, information on a connection destination 2 (for example, the first server 2-1) is stored in a duplicated manner. That is, the example in FIG. 9 is an example of a case in which a plurality of networks at mobile destinations notifies the communication terminal 1 of operation policies each of which prescribes that connection to a predetermined connection destination 2 (for example, the first server 2-1) from the network is allowed. In FIG. 9, the operation policy in the second row and the operation policy in the fourth row are information on the first server 2-1. In such a case, the communication unit 12 selects a communication interface 11 that is used in communication with the connection destination 2, using an operation policy notified most recently (latest operation policy). The communication unit 12 may also select a communication interface 11 that is used in communication with the connection destination 2 based on, for example, an operation policy selected at random out of operation policies stored in a duplicated manner.

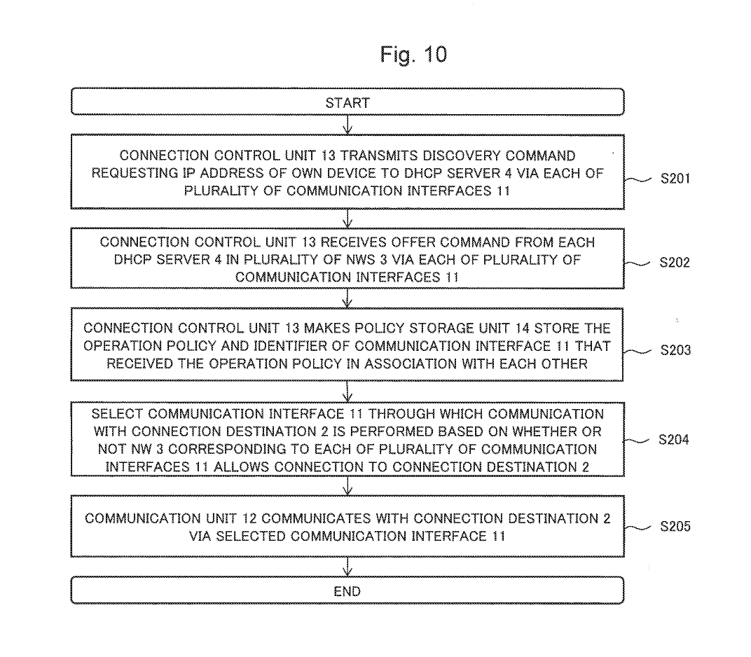

FIG. 10 is a flowchart illustrating an operation example of the communication terminal 1 in the second exemplary embodiment of the present invention.

When the communication unit 12 starts communication with a connection destination 2, the connection control unit 13 transmits a DISCOVERY command requesting an IP address of the own device to each DHCP server 4 by way of one of the plurality of communication interfaces 11 (S201).

The connection control unit 13 receives an OFFER command from each DHCP server 4 in one of the plurality of NWs 3 by way of one of the plurality of communication interfaces 11 (S202).

When an operation policy of a NW 3 is included in a predetermined area in an OFFER command, the connection control unit 13 stores, in the policy storage unit 14, the operation policy and the identifier of the communication interface 11 that has received the operation policy in association with each other (S203).

When starting communication, the communication unit 12, referring to the policy storage unit 14, selects a communication interface 11 through which communication with the connection destination 2 is performed based on whether or not a NW 3 corresponding to each of the plurality of communication interfaces 11 allows connection to the connection destination 2 (S204).

The communication unit 12 communicates with the connection destination 2 by way of the selected communication interface 11 (S205).

When, in storing an operation policy in association with the identifier of a communication interface 11, another operation policy has been associated with the identifier of the communication interface 11, the policy storage unit 14 may delete the another operation policy. After deleting the another operation policy, the policy storage unit 14 stores the new operation policy.

When, for example, connection to a NW 3 is cut off because of movement of the communication terminal 1 or a user of the communication terminal 1 manually cuts off connection to a NW 3, the policy storage unit 14 may delete stored information. When, for example, the communication terminal 1 leaves a place at which the communication terminal 1 can be connected to a corporate intranet and connection to the corporate intranet is cut off, the communication terminal 1 deletes an operation policy(ies) related to the corporate intranet. When, for example, the communication terminal 1 moves to a place at which the communication terminal 1 can be connected to a corporate intranet, the communication terminal 1 may delete an operation policy(ies) related to an external network to which the communication terminal 1 has been connected until then. When the communication terminal 1 is able to connect to the external network continuingly, the communication terminal 1 does not have to delete the operation policy(ies).

In the example in FIG. 4, when, for example, connection to the first Wi-Fi 3-1 is cut off, the communication terminal 1 deletes an operation policy(ies) of the first Wi-Fi 3-1. That is, the communication terminal 1 deletes an operation policy(ies) related to the connection destination having properties of “Protocol=TCP, URL=http://example02a.com/, port=80”, which is/are stored in the policy storage unit 14 and illustrated in FIG. 6 or 7.

When the communication terminal 1 cuts off connection to a NW 3, the connection control unit 13 may notify the policy storage unit 14 of the identifier of a communication interface 11 corresponding to the cut-off NW 3. In this case, the policy storage unit 14 deletes an operation policy(ies) stored in association with the notified identifier of the communication interface 11.

For example, when connection to the Wi-Fi 3-2 is cut off, the policy storage unit 14 is notified, by the connection control unit 13, of the identifier of the communication interface 11-2, which corresponds to the wireless LAN 3-2, and deletes information on the server B2-2 stored in association with the notified identifier.

When starting communication, the communication unit 12 refers to the policy storage unit 14 to check whether or not information on the other side of communication is stored. When information on the other side of communication is stored in the policy storage unit 14, the communication unit 12 starts communication, using the information. For example, when the communication unit 12 is to connect to the second server 2-2, the communication unit 12 refers to the policy storage unit 14 to recognize that the communication unit 12 is able to connect to the second server 2-2 by way of the communication interface 11-2. The communication unit 12, based on the recognition, connects to the server 2-2, using the communication interface 11-2.

On the other hand, when no information on the other side of communication is stored in the policy storage unit 14, the communication unit 12, using the communication interface 11-1, which is designated as the “default” communication interface, starts communication with the other side of communication.

Although, in the above-described example, each DHCP server 4 notifies the communication terminal 1 of an operation policy(ies) of a NW 3, the device that notifies an operation policy(ies) may be a DNS (Domain

Name System) server. In such a case, a DNS server incorporates an operation policy(ies) of a NW 3 in which the own device is installed into a response to an inquiry about the address of a connection destination 2 from the communication terminal 1.

As described above, in the second exemplary embodiment of the present invention, each DHCP server 4 incorporates an operation policy(ies) of a NW 3 into a response to a request for an address that the communication terminal 1 uses. Therefore, the communication terminal 1 is capable of selecting a communication interface 11 through which communication with the connection destination 2 is performed based on whether or not a NW 3 corresponding to each of the plurality of communication interfaces 11 allows connection to the connection destination 2. The capability enables the communication terminal 1 to select a communication interface in accordance with features of access networks.

### Third Exemplary Embodiment

A third exemplary embodiment of the present invention will be described below with reference to the drawings. In the third exemplary embodiment of the present invention, a description of the same configurations as those of the first and second exemplary embodiments of the present invention will be omitted.

In the third exemplary embodiment of the present invention, a communication terminal 1 receives an operation policy(ies) of each of a plurality of NWs 3 from a management device 6 that manages the operation policy(ies) of each NW 3 and, based on the received policy(ies), selects a communication interface 11 through which communication with a connection destination 2 is performed.

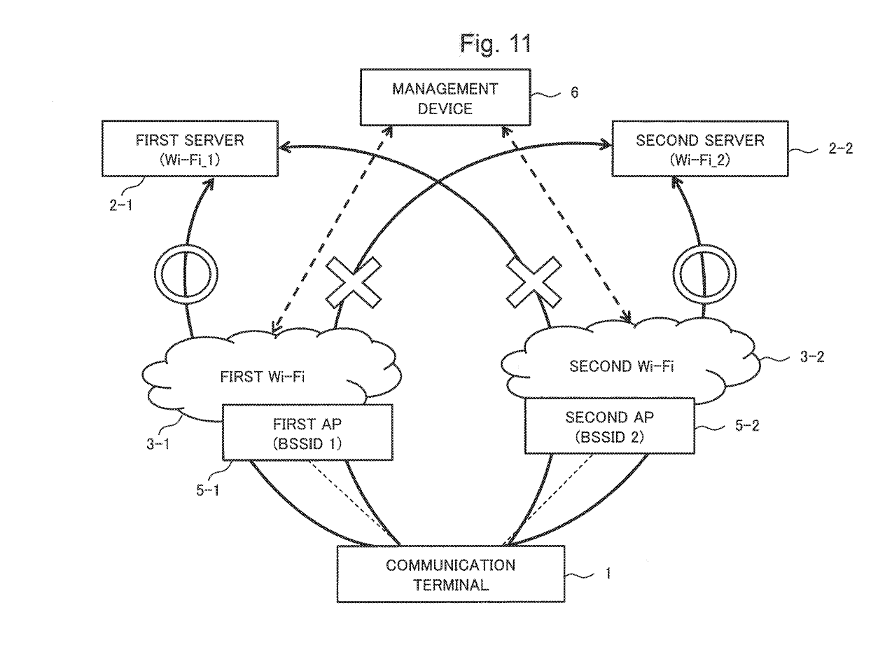

FIG. 11 is a diagram illustrating a configuration example of a communication system in the third exemplary embodiment of the present invention. The communication system includes the communication terminal 1, a plurality of servers 2 (in the example in FIG. 11, a first server 2-1 and a second server 2-2), and a plurality of NWs 3 (in the example in FIG. 11, a first Wi-Fi 3-1 and a second Wi-Fi 3-2). The communication system also includes a plurality of APs (Access Point) 5 each of which is installed in one of the plurality of NWs 3 and the management device 6.

Each AP 5 is a device that relays communication between the communication terminal 1 and a NW 3. Each AP 5 has an identifier that can uniquely identify the AP 5. Such an identifier is, for example, a

BSSID (Basic Service Set Identifier), which is the MAC address of an AP. As illustrated in FIG. 11, the first Wi-Fi 3-1 includes a first AP 5-1. The second Wi-Fi 3-2 includes a second AP 5-2.

The management device 6 manages an operation policy(ies) of each of the plurality of NWs 3. The management device 6 collects an operation policy(ies) from each of the plurality of NWs 3 and stores the collected operation policy(ies).

The management device 6 may be, for example, a Web server or the like, and may disclose collected operation policies of the plurality of NWs 3 on a global network, such as the Internet.

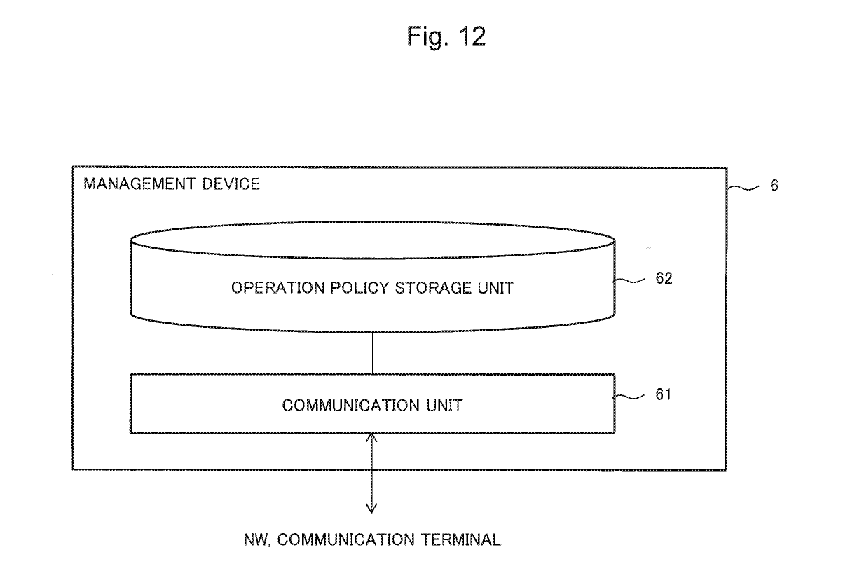

FIG. 12 is a diagram illustrating a configuration example of the management device 6. As illustrated in FIG. 12, the management device 6 includes a communication unit 61 and an operation policy storage unit 62.

The operation policy storage unit 62 stores the operation policy(ies) collected from each of the plurality of NWs 3.

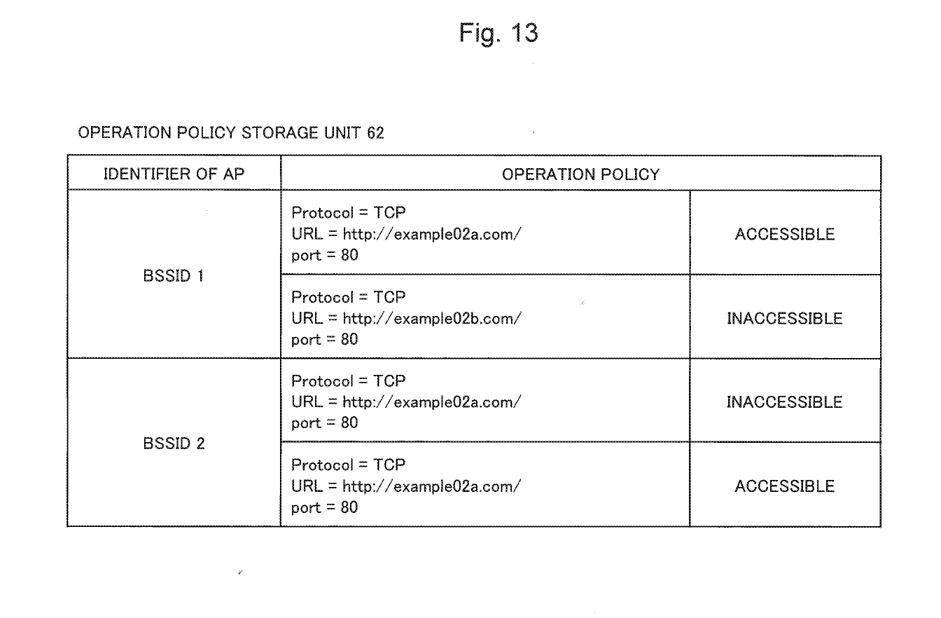

FIG. 13 illustrates an example of operation policies that the operation policy storage unit 62 stores. The operation policy storage unit 62 uses, for example, BBSIDs, which are the identifiers of the APs 5 each of which is installed in one of the plurality of NWs 3, to discriminate the plurality of NWs 3 from one another. As illustrated in FIG. 13, the operation policy storage unit 62 stores the identifiers (BSSIDs) of APs and operation policies of NWs 3 to which the APs are installed in association with each other. For example, the operation policy storage unit 62 stores “BBSID 1”, which is the identifier of the AP 5-1, and operation policies of the first Wi-Fi 3-1 (policies indicating whether or not the first Wi-Fi 3-1 allows connection to a first server and a second server) in association with each other. The operation policy storage unit 62 may also store the identifiers of APs and information on connection destinations 2 that allow connection by way of respective NWs 3 in association with each other. In such a case, the operation policy storage unit 61 stores only accessible connection destinations 2 in association with BBSIDs and does not have to store whether “accessible” or “inaccessible”.

Administrators who administrate the respective NWs 3 may register information stored in the operation policy storage unit 62 in advance. For example, when a NW 3 is a corporate intranet, the administrator of the NW 3 may register, in advance, a connection destination(s) 2 the access to which from the corporate intranet is restricted. An operation policy on whether “accessible” or “inaccessible” may be set based on information on a keyword or a domain linked to a connection destination 2 the access to which from a corporate intranet is restricted.

When a NW 3 is a local network or a private network that is available for use by customers at a shop and the like, the administrator of the NW 3 may register, in advance, a connection destination(s) 2 that is/are accessible from the local network or the private network.

The communication unit 61 receive an operation policy(ies) from each of the plurality of NWs 3. The communication unit 62 receives, from at least one of the plurality of NWs 3, a notification of an association relationship between an operation policy of the NW 3 and the identifier (BSSID) of an AP 5 included in the NW 3. The communication unit 61 stores the notified association relationship in the operation policy storage unit 62.

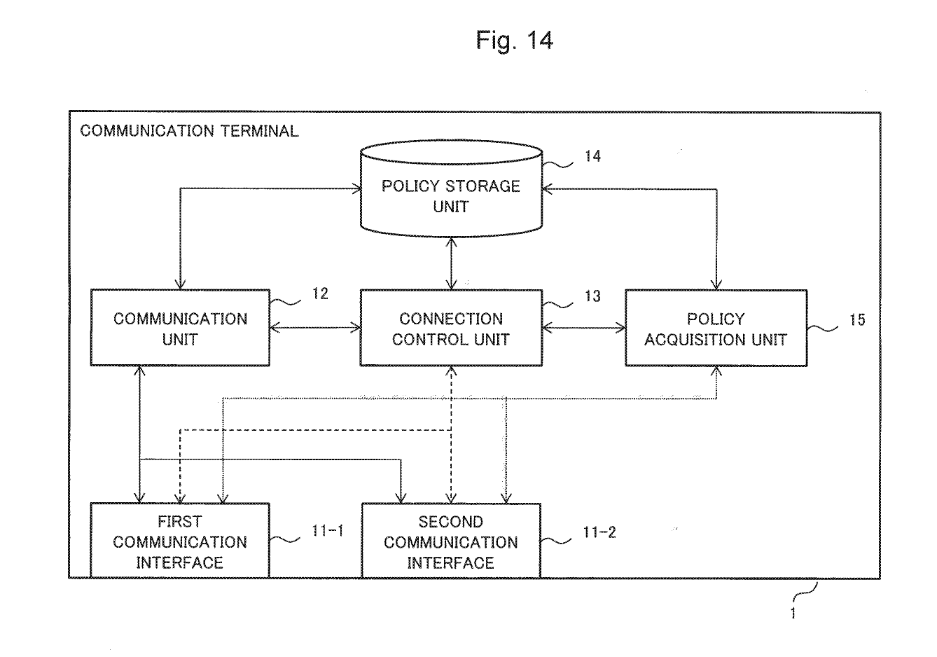

FIG. 14 is a diagram illustrating a configuration example of the communication terminal 1 in the third exemplary embodiment of the present invention. As illustrated in FIG. 14, the communication terminal 1 includes a plurality of communication interfaces 11 (in the example in FIG. 14, a first communication interface 11-1 and a second communication interface 11-2), a communication unit 12, a connection control unit 13, a policy storage unit 14, and a policy acquisition unit 15.

The connection control unit 13 is capable of executing search for an AP by way of a communicable communication interface (for example, the first the communication interface 11-1). For example, the connection control unit 13 executes search for an AP by way of the first communication interface to find the second AP 5-2 illustrated in FIG. 11. The connection control unit 13, which has found the second AP 5-2, performs connection processing to the newly found second AP 5-2, using the second communication interface.

The policy acquisition unit 15 acquires operation policies of the NWs 3 from the management device 6. To acquire, for example, an operation policy of the Wi-Fi 3-2, the policy acquisition unit 15 transmits a request including the identifier (BSSID 2) of the AP 5-2 in the Wi-Fi 3-2 to the management device 6. The policy acquisition unit 15 requests operation policies of the NWs 3 to the management device 6 when, for example, the communication unit 12 starts communication with a server 2. The policy acquisition unit 15 may also request operation policies of the NWs 3 to the management device 6 when, for example, the connection control unit 13 has started connection processing. Occasions on which the policy acquisition unit 15 requests operation policies to the management device 6 are not limited to these examples, and the policy acquisition unit 15 may, for example, request operation policies to the management device 6 regularly. The policy acquisition unit 15 may also receive operation policies of the NWs 3 that the management device 6 has autonomously transmitted.

The policy acquisition unit 15 is notified of operation policies of the NWs 3 by the management device 6 and stores the notified operation policies in the policy storage unit 14.

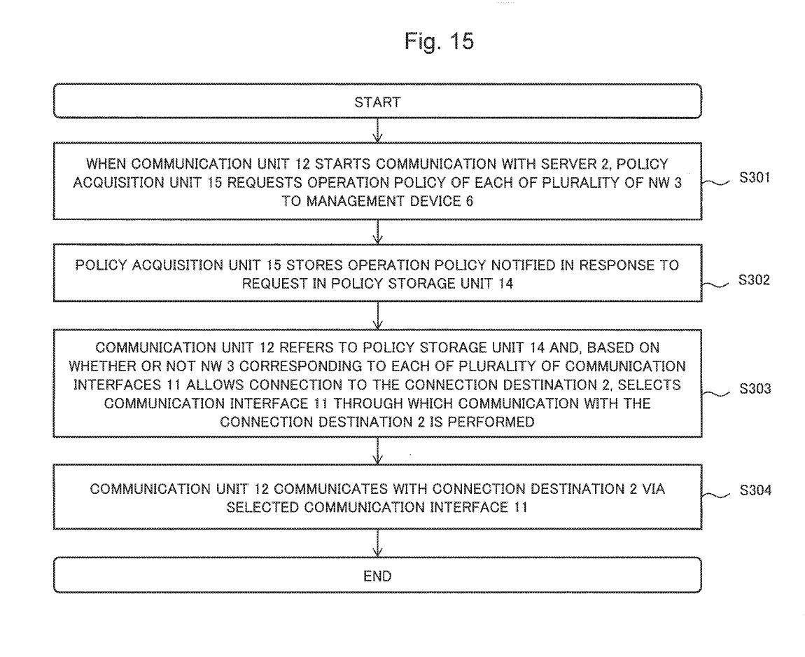

FIG. 15 is a flowchart illustrating an operation example of the communication terminal 1 in the third exemplary embodiment of the present invention.

When the communication unit 12 starts communication with a server 2, the policy acquisition unit 15 requests an operation policy of each of the plurality of NWs 3 to the management device 6 (S301).

The policy acquisition unit 15 stores operation policies that have been notified in response to the requests in the policy storage unit 14 (S302).

When starting communication, the communication unit 12 refers to the policy storage unit 14 and, based on whether or not a NW 3 corresponding to each of the plurality of communication interfaces 11 allows connection to the connection destination 2, selects a communication interface 11 through which communication with the connection destination 2 is performed (S303).

The communication unit 12 performs communication with the connection destination 2 by way of the selected communication interface 11 (S304).

As described above, in a fifth exemplary embodiment of the present invention, the communication terminal 1 receives notifications of operation policies of the NWs 3 from the management device and, based on the received policies, selects a communication interface 11 through which communication with a connection destination 2 is performed. The capability enables the communication terminal 1 to select a communication interface in accordance with features of access networks.

### Fourth Exemplary Embodiment

A fourth exemplary embodiment of the present invention will be described below with reference to the drawings. In the fourth exemplary embodiment of the present invention, a description of the same configurations as those of the first to fourth exemplary embodiments of the present invention will be omitted.

The fourth exemplary embodiment of the present invention will be described with reference to the drawings. The fourth exemplary embodiment of the present invention is an exemplary embodiment in which the present invention is embodied by improving and applying a technology referred to as OpenFlow, which is a network architecture of a concentrated control type. The fourth exemplary embodiment can be applied to any one of the above-described exemplary embodiments.

OpenFlow recognizes communication as an end-to-end flow and can perform routing control and the like of each flow.

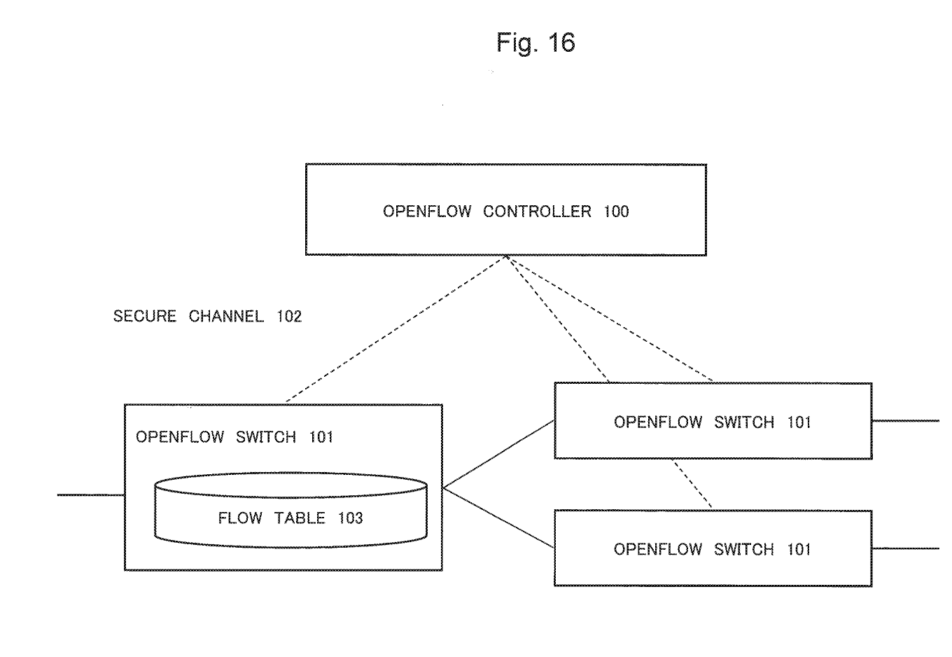

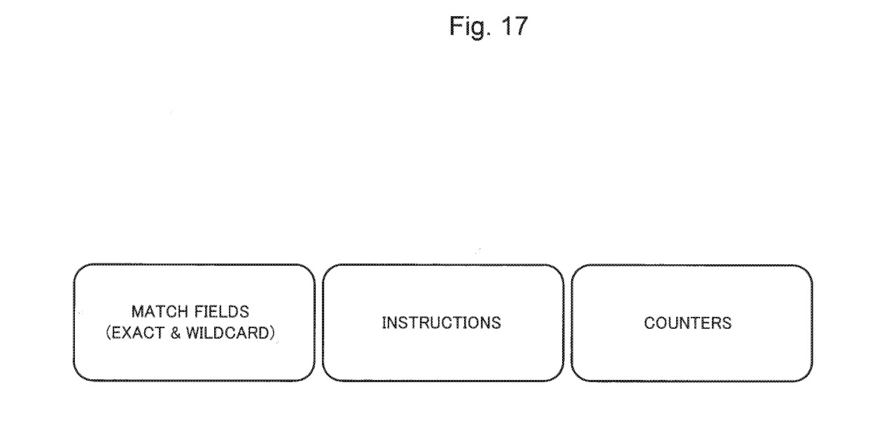

With reference to FIGS. 16 and 17, OpenFlow will be described.

FIG. 16 illustrates an outline of a communication system configured based on the OpenFlow technology. A flow is, for example, a series of communication packets that have a predetermined attribute (an attribute that is identified based on a destination of communication, a transmission source, or the like). An OpenFlow switch 101 is a network switch that employs the OpenFlow technology. An OpenFlow controller 100 is an information processing device that controls the OpenFlow switches 101.

Each OpenFlow switch 101 communicates with the OpenFlow controller 100 by way of a secure channel 102, which is set up between the OpenFlow switch 101 and the OpenFlow controller 100. The OpenFlow controller 100, by way of the secure channel 102, performs setting of a flow table 103 of each OpenFlow switch 101. Each secure channel 102 is a communication path to which countermeasures against eavesdropping, tampering, and the like on communication between a switch and a controller have been applied.

FIG. 17 illustrates a configuration example of each entry (flow entry) in each flow table 103. A flow entry is made up of a matching rule (Match Fields) to be matched with information included in the headers of packets that a switch has received (for example, a destination IP address, a VLAN ID, and the like), statistics information (Counters) that is statistics information of each packet flow, and instructions (Instructions) prescribing a processing method of packets that match the matching rule.

When receiving a packet, each OpenFlow switch 101 refers to the flow table 103 thereof. The OpenFlow switch 101 searches for a flow entry that matches the header information of the received packet. When an entry that matches the header information of the received packet is found, the OpenFlow switch 101 processes the received packet in accordance with the processing method defined in the Instructions field of the found entry. Prescribed processing methods include, for example, “transferring a received packet from a predetermined port”, “discarding a received packet”, and “rewriting a portion of the header of a received packet and transferring the packet from a predetermined port”.

On the other hand, when no entry that matches the header information of the received packet is found, the OpenFlow switch 101, for example, transfers the received packet to the OpenFlow controller 100 by way of the secure channel 102 thereof. The OpenFlow switch 101, by means of transferring the received packet, requests the OpenFlow controller 100 to set a flow entry that prescribes a processing method of the received packet. When a flow entry that prescribes, as a processing method of a packet, transmitting a request to the controller matches the packets, the OpenFlow switch 101 may, in accordance with the processing method, request the controller to set a flow entry.

The OpenFlow controller 100 determines a processing method of the received packet and sets a flow entry including the determined processing method into the flow table 103. Subsequently, the OpenFlow switch 101 processes succeeding packets that belong to the same flow as the received packet in accordance with the set flow entry.

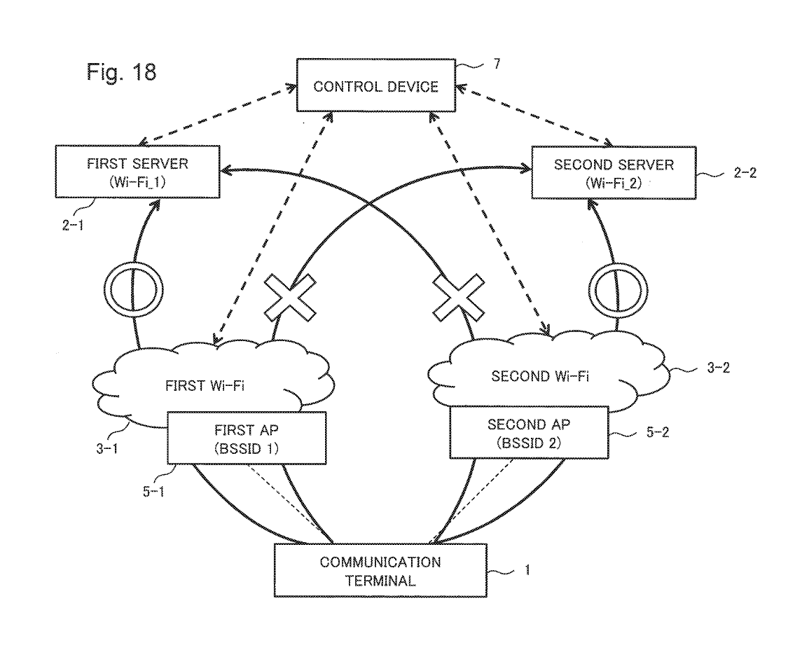

FIG. 18 is a diagram illustrating a configuration example of a communication system in the fourth exemplary embodiment of the present invention. The communication system includes a communication terminal 1, connection destinations 2 (a first server 2-1 and a second server 2-2), a plurality of NWs 3 (a first Wi-Fi 3-1 and a second Wi-Fi 3-2), APs 5 (a first AP 5-1 and a second AP 5-2), and a control device 7.

The control device 7 is, for example, an OpenFlow controller and is capable of communicating with the communication terminal 1 in accordance with the OpenFlow protocol. The control device 7 may communicate with the communication terminal 1 in accordance with the OpenFlow protocol, for example, by way of either the first Wi-Fi 3-1 or the second Wi-Fi 3-2.

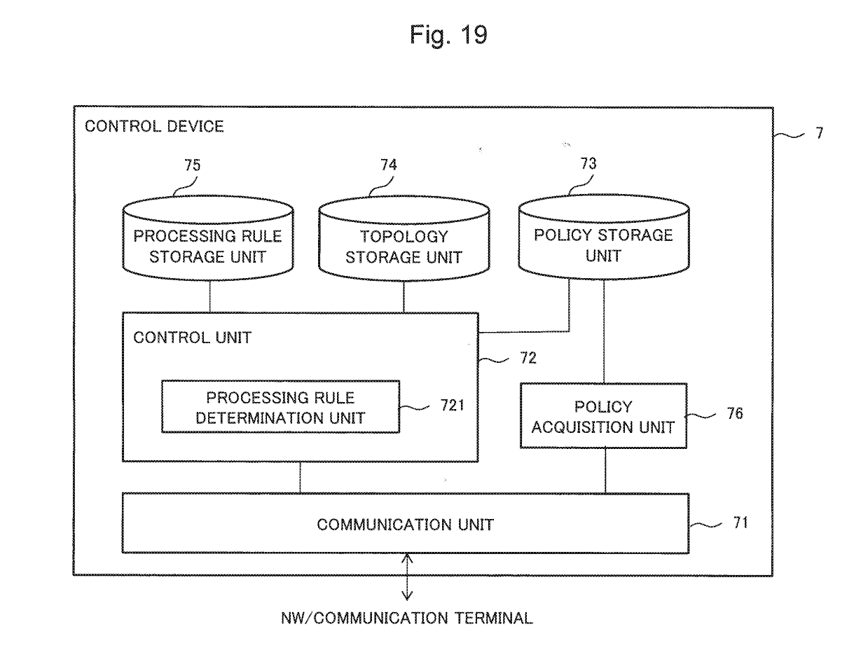

FIG. 19 is a diagram illustrating a configuration example of the control device 7 in the fourth exemplary embodiment of the present invention. The control device 7 has a communication unit 71, a control unit 72, a policy storage unit 73, a topology storage unit 74, a processing rule storage unit 75, and a policy acquisition unit 76.

The communication unit 71 has a function of communicating with the communication terminal 1 based on the OpenFlow protocol. The communication unit 71 receives, from the communication terminal 1, a request for a processing rule of a packet (equivalent to a “flow entry” described above). The communication unit 71 notifies the communication terminal 1 of a processing rule.

The policy storage unit 73 stores the same information as that in the policy storage unit 14 in the respective exemplary embodiments described above. The policy storage unit 73 stores information on the servers 2 each of which connects to one of the NWs 3, which is acquired by way of the communication unit 71, in accordance with an instruction from the control unit 72.

The topology storage unit 74 stores information on adjacency between switches conforming to the OpenFlow protocol and information on the network, such as the bandwidth of a link. In the exemplary embodiment, the communication terminal 1 conforming to OpenFlow has a function of notifying a controller (the control device 7) of a status of a port of the communication terminal 1 (Port Status) and a function of notifying the controller of features of the communication terminal 1 (Feature Request/Reply). Information stored in the topology storage unit 74 may be collected using the above-described functions.

The policy acquisition unit 76 collects, from each of the plurality of

NWs 3, an operation policy(ies) of the NW 3. The policy acquisition unit 76 collects, from the communication terminal 1, an operation policy(ies) notified by, for example, each DHCP server 4 (not illustrated in FIG. 18), which was described in the second exemplary embodiment, using, for example, a function of the communication terminal 1 notifying a controller (the control device 7) of features thereof. The policy acquisition unit 76 may also collect an operation policy(ies) of each NW 3 directly from a corresponding DHCP server 4 or, for example, a management device 6 (not illustrated in FIG. 18), which was described in the third exemplary embodiment.

A processing rule determination unit 721 in the control unit 72 determines a processing rule to be set to the communication terminal 1. The processing rule determination unit 72 refers to information that is held in the policy storage unit 73, the topology storage unit 74, and the processing rule storage unit 75 to generate a processing rule to be set to the communication terminal 1.

The control unit 72, referring to the policy storage unit 73, is able to select a communication interface 11 that the communication terminal 1 uses in communication with a connection destination 2. The control unit 72 generates a processing rule including an identification rule (“Match Fields”) for identifying a flow related to communication with a connection destination 2 and an instruction (“Instruction”) indicating transferring packets belonging to a flow that matches the identification rule to a selected communication interface 11.

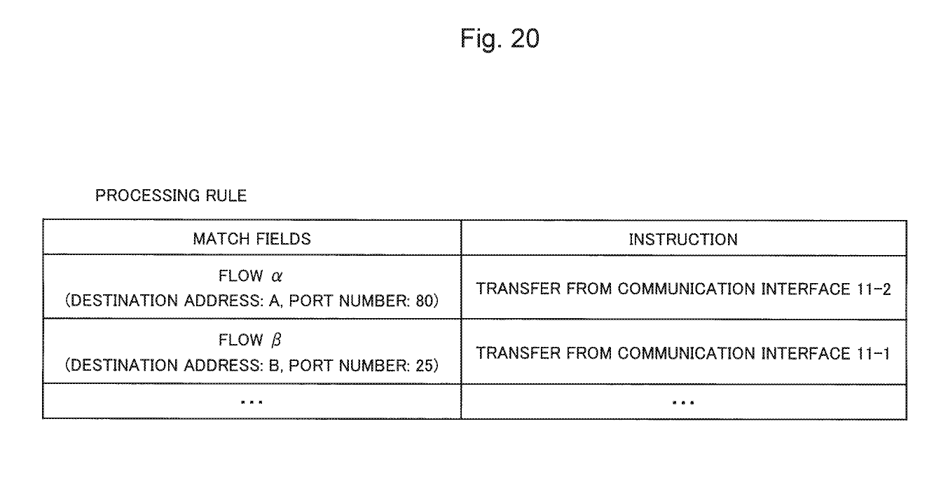

FIG. 20 illustrates an example of processing rules that the processing rule determination unit 721 in the fourth exemplary embodiment of the present invention generates. The example in FIG. 20 is processing rules to be set to the communication terminal 1. The processing rule determination unit 721, for example, prescribes the destination address of a packet and the port number of the packet as a matching rule. The processing rule determination unit 721, for example, prescribes, as a processing method “Instruction” corresponding to a matching rule, a processing method of transferring a packet addressed to the second server 2-2 from the communication interface 11-2 of the communication terminal 1.

In the example in FIG. 20, the matching rule in the first row in the processing rules is a “flow α (a destination address “A”, which is the destination address of the second server 2-2, and a port number “80”)”. The instruction of the processing rule in the first row indicates “transferring a packet from the communication interface 11-2”. The matching rule in the second row in the processing rules is a “flow β (a destination address “B”, which is the destination address of the first server 2-1, and a port number “25”)”. The instruction of the processing rule in the second row indicates “transferring a packet from the communication interface 11-1”.

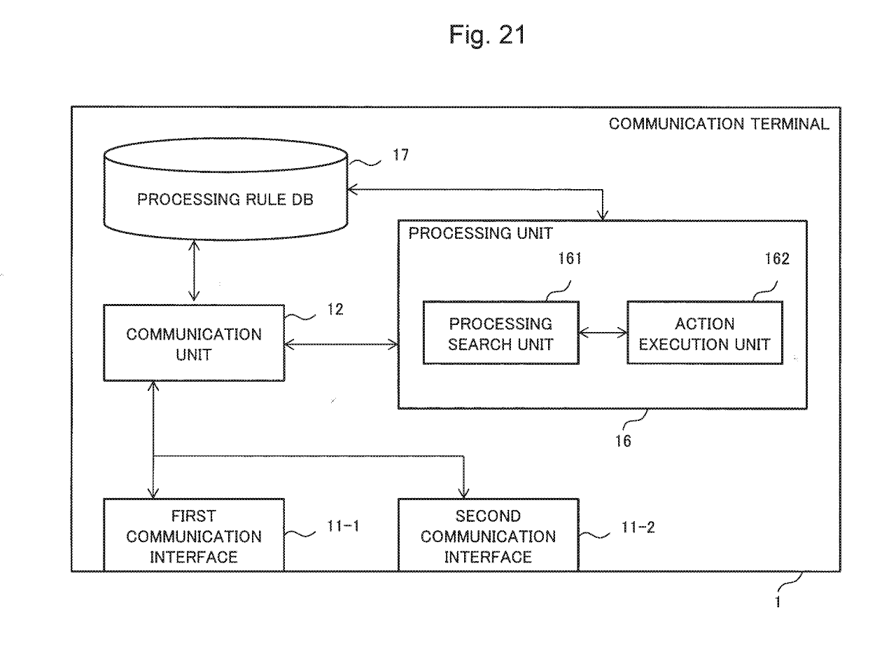

FIG. 21 illustrates an example of a configuration of the communication terminal 1 in the fourth exemplary embodiment of the present invention. As illustrated in FIG. 21, the communication terminal 1 includes a plurality of communication interfaces 11 (in the example in FIG. 21, a first communication interface 11-1 and a second communication interface 11-2), a communication unit 12, a processing unit 16, and a processing rule DB 17. The processing unit 16 has a processing search unit 161 and an action execution unit 162.

The processing unit 16 is, for example, a virtual switch configured by software. A virtual switch is capable of transferring a packet in accordance with a processing rule based on the OpenFlow protocol.

At least one of the communication interfaces 11 communicates with the control device 7 in accordance with the OpenFlow protocol. Each of the plurality of communication interfaces 11 connects to a NW 3 corresponding thereto.

The processing rule DB 17 stores processing rules notified by the control device 7.

The processing unit 16 processes a packet in accordance with a processing rule notified by the control device 7. The processing unit 16, for example, receives a packet from a communication application (Web browser and the like) and processes the packet in accordance with a processing rule.

The processing search unit 161 searches the processing rule DB 17 for a processing rule corresponding to a received packet. The action execution unit 162, by matching a packet with the “Matching Fields” of processing rules stored in the processing rule DB 17, searches for a processing rule corresponding to the packet.

The communication unit 12 processes a packet in accordance with a processing method prescribed in the “Instruction” field of a found processing rule.

When, for example, no processing rule corresponding to a received packet exists in the processing rule DB 42, the processing search unit 161 requests the controller 3 to set a processing rule.

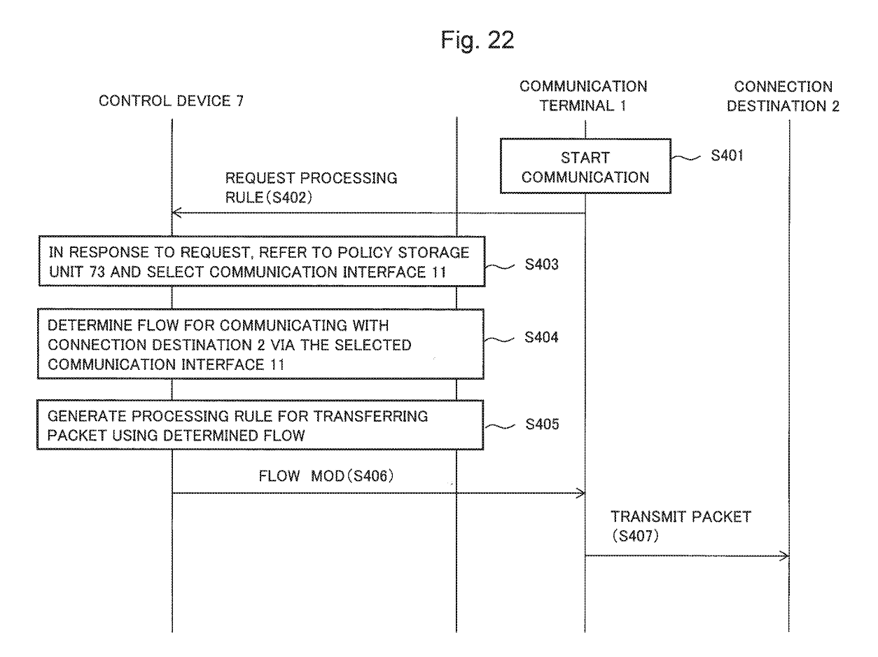

FIG. 22 is a sequence diagram illustrating an operation example of the fourth exemplary embodiment of the present invention.

In the fourth exemplary embodiment of the present invention, when the communication terminal 1 starts communication with a connection destination 2 (S401), the communication terminal 1 requests the control device 7 to provide a processing rule for processing a packet to be transmitted to the connection destination 2 (S402).

The control unit 72 of the control device 7, responding to the request, refers to the policy storage unit 73 to select a communication interface 11 that the communication terminal 1 uses in communication with the connection destination 2 (S403). The control unit 72 determines a flow for communicating with the server 2 by way of the selected communication interface 11 (S404). The control unit 72 generates a processing rule for transferring a packet using the flow (S405).

The control device 7 notifies the communication terminal 1 of the processing rule for transferring a packet (Flow Mod in S406).

The communication terminal 1, based on the processing rule notified by the control device 103, transfers a packet (S407).

According to a seventh exemplary embodiment of the present invention, the present invention can be embodied by improving and applying a technology referred to as OpenFlow, which is a network architecture of a concentrated control type.

### Fifth Exemplary Embodiment

In a fifth exemplary embodiment of the present invention, a computer, a CPU (Central Processing Unit), an MPU (Micro-Processing Unit), or the like in a communication terminal 1 executes software (program) achieving the functions of the respective exemplary embodiments described above.

In the fifth exemplary embodiment of the present invention, the communication terminal 1 obtains software (program) achieving the functions of the respective exemplary embodiments described above by way of various storage media, such as a CD-R (Compact Disc Recordable), or a network. A program that the communication terminal 1 obtains or a storage medium storing the program constitutes the present invention. The software (program) may be stored in, for example, a predetermined storage unit included in the communication terminal 1 in advance.

The computer, CPU, MPU, or the like in the communication terminal 1 reads and executes a program code of the obtained software (program). Therefore, the communication terminal 1 executes the same processing as those of the control device 1, controller 3, or control device 5 in the respective exemplary embodiments described above.

The fifth exemplary embodiment of the present invention enables the present invention to be applied to a use as a program for embodying the functions of the respective exemplary embodiments on the computer, CPU, MPU, or the like in the communication terminal 1.

The present invention was described above through exemplary embodiments thereof, but the present invention is not limited to the respective exemplary embodiments described above. The present invention can be carried out based on any modification, substitution, or adjustment of each exemplary embodiment. The present invention can also be carried out by arbitrarily combining respective exemplary embodiments. In other words, the present invention includes various modifications and alterations that can be achieved according to the entire disclosure and technical ideas of the specification.

All or part of the exemplary embodiments described above may be described as in the following supplemental notes, but the present invention is not limited thereto.

### [Supplemental Note 1]

A communication terminal that communicates with a connection destination by way of at least one of a plurality of networks, including:

a plurality of communication interfaces each of which corresponds to at least one of the plurality of networks; and

a communication means capable of selecting the communication interface through which communication with the connection destination is performed based on whether or not a network corresponding to each of the plurality of communication interfaces is communicable with the connection destination.

### [Supplemental Note 2]

The communication terminal according to Supplemental note 1, wherein

the communication means is capable of, in accordance with an operation policy of each of the plurality of networks, selecting the communication interface through which communication with the connection destination is performed.

### [Supplemental Note 3]

The communication terminal according to Supplemental note 1 or 2, wherein

the communication means is capable of, based on whether or not access to the connection destination is restricted in each of the plurality of networks, selecting the communication interface through which communication with the connection destination is performed.

### [Supplemental Note 4]

The communication terminal according to any one of Supplemental notes 1 to 3, wherein

the communication means selects a communication interface corresponding to a network that is communicable with the connection destination as the communication interface through which communication with the connection destination is performed.

### [Supplemental Note 5]

The communication terminal according to any one of Supplemental notes 1 to 4, wherein

the communication means, from at least one of the plurality of networks, receives an operation policy of the network and is capable of, based on the policy, selecting the communication interface through which communication with the connection destination is performed.

### [Supplemental Note 6]

The communication terminal according to any one of Supplemental notes 1 to 5, wherein

the communication means receives an operation policy included in a response to a request for an address that the communication terminal uses and is capable of, based on the policy, selecting the communication interface through which communication with the connection destination is performed.

### [Supplemental Note 7]

The communication terminal according to any one of Supplemental notes 1 to 6, further including:

a storage means for storing information on the connection destination and a communication interface corresponding to a network that is communicable with the connection destination in association with each other,

wherein the communication means refers to the storage means to select a communication interface through which communication with the connection destination is performed.

### [Supplemental Note 8]

The communication terminal according to any one of Supplemental notes 1 to 7, wherein

the communication means receives the operation policy from a management device that manages an operation policy of each of the plurality of networks and is capable of, based on the policy, selecting the communication interface through which communication with the connection destination is performed.

### [Supplemental Note 9]

A communication system, including:

the communication terminal according to any one of Supplemental notes 1 to 8; and

the connection destination.

### [Supplemental Note 10]

The communication system according to Supplemental note 9, further including:

a server that, in response to a request from the communication terminal, returns an address that is usable by the communication terminal,

wherein the server incorporates an operation policy of the network into a response returning the address.

### [Supplemental Note 11]

The communication system according to Supplemental note 9 or 10, further including:

a management device that manages an operation policy of each of the plurality of networks,

wherein the management device notifies the communication terminal of an operation policy of the network.

### [Supplemental Note 12]

A communication method, the method including:

communicating with a connection destination by way of at least one of a plurality of networks,

wherein, based on whether or not a network corresponding to each of a plurality of communication interfaces each of which corresponds to at least one of the plurality of networks is communicable with the connection destination, the communication interface through which communication with the connection destination is performed is selectable.

### [Supplemental Note 13]

The communication method according to Supplemental note 12, wherein

in accordance with an operation policy of each of the plurality of networks, the communication interface through which communication with the connection destination is performed is selectable.

### [Supplemental Note 14]

The communication method according to Supplemental note 12 or 13, wherein

based on whether or not, at each of the plurality of networks, access to the connection destination is restricted, the communication interface through which communication with the connection destination is performed is selectable.

### [Supplemental Note 15]

The communication method according to any one of Supplemental notes 12 to 14, wherein

a communication interface corresponding to a network that is communicable with the connection destination is selected as the communication interface through which communication with the connection destination is performed.

### [Supplemental Note 16]

The communication method according to any one of Supplemental notes 12 to 15, wherein

from at least one of the plurality of networks, an operation policy of the network is received, and

based on the policy, the communication interface through which communication with the connection destination is performed is selectable.

### [Supplemental Note 17]

The communication method according to any one of Supplemental notes 12 to 16, wherein

an operation policy incorporated in a response to a request for an address that an own device uses is received, and

based on the operation policy, the communication interface through which communication with the connection destination is performed is selectable.

### [Supplemental Note 18]

The communication method according to any one of Supplemental notes 12 to 17, wherein

information on the connection destination and a communication interface corresponding to a network that is communicable with the connection destination are stored in association with each other, and

with reference to the stored association, a communication interface through which communication with the connection destination is performed is selected.

### [Supplemental Note 19]

The communication method according to any one of Supplemental notes 12 to 18, wherein

from a management device that manages an operation policy of each of the plurality of network, the operation policy is received, and

based on the policy, the communication interface through which communication with the connection destination is performed is selectable.

### [Supplemental Note 20]

A storage medium storing a program, the program making a computer execute:

a process of communicating with a connection destination by way of at least one of a plurality of networks; and

a process in which, based on whether or not a network corresponding to each of a plurality of communication interfaces each of which corresponds to at least one of the plurality of networks is communicable with the connection destination, the communication interface through which communication with the connection destination is performed is selectable.

### [Supplemental Note 21]

The storage medium storing the program according to Supplemental note 22, the program including:

a process in which, in accordance with an operation policy of each of the plurality of networks, the communication interface through which communication with the connection destination is performed is selectable.

### [Supplemental Note 22]

The storage medium storing the program according to Supplemental note 20 or 21, the program including:

a process in which, based on whether or not, in each of the plurality of network, access to the connection destination is restricted, the communication interface through which communication with the connection destination is performed is selectable.

### [Supplemental Note 23]

The storage medium storing the program according to any one of Supplemental notes 20 to 22, the program including:

a process of selecting a communication interface corresponding to a network that is communicable with the connection destination as the communication interface through which communication with the connection destination is performed.

### [Supplemental Note 24]

The storage medium storing the program according to any one of Supplemental notes 20 to 23, the program including:

a process of, from at least one of the plurality of networks, receiving an operation policy of the network; and

a process in which, based on the policy, the communication interface through which communication with the connection destination is performed is selectable.

### [Supplemental Note 25]

The storage medium storing the program according to any one of Supplemental notes 20 to 24, the program including:

a process of receiving an operation policy incorporated in a response to a request for an address that an own device uses; and

a process in which, based on the operation policy, the communication interface through which communication with the connection destination is performed is selectable.

### [Supplemental Note 26]

The storage medium storing the program according to any one of Supplemental notes 20 to 25, the program including:

a process of storing information on the connection destination and a communication interface corresponding to a network that is communicable with the connection destination in association with each other; and

a process of referring to the stored association to select a communication interface through which communication with the connection destination is performed.

### [Supplemental Note 27]

The storage medium storing the program according to any one of Supplemental notes 20 to 26, the program including:

a process of, from a management device that manages an operation policy of each of the plurality of networks, receiving the operation policy; and

a process in which, based on the policy, the communication interface through which communication with the connection destination is performed is selectable.

The present invention was described above through exemplary embodiments thereof, but the present invention is not limited to the above exemplary embodiments. Various modifications that could be understood by a person skilled in the art may be applied to the configurations and details of the present invention within the scope of the present invention.

This application claims priority based on Japanese Patent Application No. 2014-068372, filed on Mar. 28, 2014, the entire disclosure of which is incorporated herein by reference.

### REFERENCE SIGNS LIST

1 Communication terminal

2 Connection destination, Server

3 NW, Wi-Fi

4 DHCP server

5 AP

6 Management device

7 Control device

11 Communication interface

12 Communication unit

13 Connection control unit

14 Policy storage unit

15 Policy acquisition unit

61 Communication unit

62 Operation policy storage unit

71 Communication unit

72 Control unit

73 Policy storage unit

74 Topology storage unit

75 Processing rule storage unit

76 Policy acquisition unit

100 OpenFlow Controller

101 OpenFlow Switch

102 Secure Channel

103 Flow Table

721 Processing rule determination unit

What is claimed is:

1. A communication terminal that communicates with a connection destination via at least one of a plurality of networks, comprising:
a plurality of communication interfaces each of which corresponds to at least one of the plurality of networks; and
a communication unit configured to select the communication interface through which communication with the connection destination is performed based on whether a network corresponding to each of the plurality of communication interfaces is communicable with the connection destination.

2. The communication terminal according to claim 1,
wherein the communication unit is capable of, in accordance with an operation policy of each of the plurality of networks, selecting the communication interface through which communication with the connection destination is performed.

3. The communication terminal according to claim 1,
wherein the communication unit is capable of, based on whether access to the connection destination is restricted in each of the plurality of networks, selecting the communication interface through which communication with the connection destination is performed.

4. The communication terminal according to claim 1,
wherein the communication unit selects a communication interface corresponding to a network that is communicable with the connection destination as the communication interface through which communication with the connection destination is performed.

5. The communication terminal according to claim 1,
wherein the communication unit, from at least one of the plurality of networks, receives an operation policy of the network and is capable of, based on the policy, selecting the communication interface through which communication with the connection destination is performed.

6. The communication terminal according to claim 1,
wherein the communication unit receives an operation policy included in a response to a request for an address that the communication terminal uses and is capable of, based on the policy, selecting the communication interface through which communication with the connection destination is performed.

7. The communication terminal according to claim 1, further comprising:
a storage for storing information on the connection destination and a communication interface corresponding to a network that is communicable with the connection destination in association with each other,
wherein the communication unit refers to the storages to select a communication interface through which communication with the connection destination is performed.

8. The communication terminal according to claim 1,
wherein the communication unit receives the operation policy from a management device that manages an operation policy of each of the plurality of networks and is capable of, based on the policy, selecting the communication interface through which communication with the connection destination is performed.

9. A communication method comprising:
communicating with a connection destination via at least one of a plurality of networks,
selecting, based on whether a network corresponding to each of a plurality of communication interfaces each of which corresponds to at least one of the plurality of networks is communicable with the connection destination, the communication interface through which communication with the connection destination is performed.

10. A non-transitory computer readable medium embodying instructions for a method for a computer, the method comprising:
a process of communicating with a connection destination via at least one of a plurality of networks; and
a process of selecting, based on whether a network corresponding to each of a plurality of communication interfaces each of which corresponds to at least one of the plurality of networks is communicable with the connection destination, the communication interface through which communication with the connection destination is performed.
